(19) United States
(12) Patent Application Publication
(10) Pub. No.: US 2023/0137376 A1
(43) Pub. Date: May 4, 2023

(54) TRANSMISSION FOR A MOTOR VEHICLE DRIVE TRAIN, MOTOR VEHICLE DRIVE TRAIN AND METHOD FOR OPERATING THE TRANSMISSION

(71) Applicant: ZF Friedrichshafen AG, Friedrichshafen (DE)

(72) Inventors: Stefan Beck, Eriskirch (DE); Juri Pawlakowitsch, Kressbronn (DE); Ingo Pfannkuchen, Friedrichshafen (DE); Michael Wechs, Weißensberg (DE); Johannes Kaltenbach, Friedrichshafen (DE); Matthias Horn, Tettnang (DE); Jens Moraw, Markdorf (DE); Fabian Kutter, Kressbronn (DE); Thomas Martin, Weissensberg (DE); Uwe Griesmeier, Markdorf (DE); Gerhard Niederbrucker, Friedrichshafen (DE)

(21) Appl. No.: 17/801,658

(22) PCT Filed: Jan. 25, 2021
(86) PCT No.: PCT/EP2021/051580

§ 371 Date: Aug. 23, 2022

(30) Foreign Application Priority Data
Feb. 24, 2020 (DE) 10 2020 202 336.0

(51) Int. Cl. B60K 6/365; F16H 3/66; B60K 6/387; B60K 6/40; B60K 6/48; B60K 6/547

(52) U.S. Cl. CPC B60K 6/365; F16H 3/66; B60K 6/387; B60K 6/40; B60K 6/48; B60K 6/547; B60K 2006/4816

(57) ABSTRACT

A transmission (G) for a motor vehicle includes an electric machine (EM), a first input shaft (1), a second input shaft (5), an output shaft (2), three planetary gear sets (11, 12, 13), and at least four shift elements (SE1, SE2, SE3, SE4). Different gears are selectable by selectively actuating the at least four shift elements (SE1, SE2, SE3, SE4) and, in addition, in interaction with the electric machine (EM), different operating modes are implementable.

### CROSS-REFERENCE TO RELATED APPLICATIONS

The present application is related and claims priority to 102020202336.0 filed in the German Patent Office on Feb. 24, 2020 and is a U.S. national phase of PCT/EP2021/051580 filed in the European Patent Office on Jan. 25, 2021, both of which are incorporated by reference in their entirety for all purposes.

### FIELD OF THE INVENTION

The invention relates to generally to a transmission for a motor vehicle, including an electric machine, a first input shaft, a second input shaft, an output shaft, and a first planetary gear set, a second planetary gear set, and a third planetary gear set, wherein the planetary gear sets each include multiple elements, wherein a first, a second, a third, and a fourth shift element are provided, and wherein a rotor of the electric machine is connected to the second input shaft. The invention also relates generally to a motor vehicle drive train in which an aforementioned transmission is utilized, and to a method for operating a transmission.

### BACKGROUND

With respect to hybrid vehicles, transmissions are known which also include, in addition to a gear set, one or multiple electric machine(s). In this case, the transmission is usually configured to be multi-stage, i.e., multiple different transmission ratios are selectable, as gears, between an input shaft and an output shaft by actuating appropriate shift elements, wherein this is preferably automatically carried out. Depending on the arrangement of the shift elements, the shift elements are clutches or also brakes. The transmission is utilized in this case for suitably implementing an available tractive force of a prime mover of the motor vehicle with respect to various criteria. The gears of the transmission are mostly also utilized in interaction with the electric machine for implementing purely electric driving. Frequently, the electric machine can also be integrated in the transmission in order to implement various operating modes in different ways.

DE 10 2014 218 610 A1 describes a transmission for a hybrid vehicle, which includes, in addition to a first input shaft and an output shaft, three planetary gear sets and an electric machine. Moreover, in one variant, six shift elements are provided, via which different power paths are achieved from the first input shaft to the output shaft while implementing different gears and, in addition, different integrations of the electric machine can be configured. Here, driving under purely electric motor power can also be implemented simply by transmitting power via the electric machine.

DE102012212257 relates to a planetary transmission for a hybrid drive of a motor vehicle, having three coupled planetary gear sets, having multiple shift elements, and having at least one electric machine, which is associated with a shaft within the transmission, wherein, in a first planetary gear set, the ring gear is connectable to a housing-affixed component and the planet carrier is drivingly connected to the ring gear of a second planetary gear set, wherein, in the second planetary gear set, the planet carrier is connected to the ring gear of a third planetary gear set and the sun gear is drivable by a transmission input shaft, and wherein, in the third planetary gear set, the planet carrier is connected to a transmission output shaft. Moreover, it is provided that the sun gear of the first planetary gear set is connected to the housing-affixed component, and that the sun gear of the third planetary gear set is connectable to the housing-affixed component and to the ring gear of the first planetary gear set.

### SUMMARY OF THE INVENTION

Example aspects of the present invention provide an alternative embodiment of the transmission for a motor vehicle known from the prior art, with which, in combination with a compact design, different operating modes can be implemented in a suitable way. In particular, example aspects of the present invention provide a compact hybrid transmission in the form of a planetary transmission for front-mounted transverse installation in motor vehicle drive trains.

According to example aspects of the invention, a transmission includes an electric machine, a first input shaft, a second input shaft, an output shaft, as well as a first planetary gear set, a second planetary gear set, and a third planetary gear set. The planetary gear sets include multiple elements, wherein, preferably, a first element, a second element, and a third element are associated with each of the planetary gear sets. In addition, a first shift element, a second shift element, a third shift element, and a fourth shift element are provided, via the selective actuation of which different power paths can be brought about by shifting different gears. It is particularly preferred when precisely four gears, which differ in terms of the transmission ratio, can be formed between the first input shaft and the output shaft. Moreover, a rotor of the electric machine is connected to the second input shaft.

Within the meaning of the invention, a “shaft” is understood to be a rotatable component of the transmission, via which associated components of the transmission are rotationally fixed to one another or via which a connection of this type is established upon actuation of an appropriate shift element. The particular shaft can connect the components to one another axially or radially or also both axially and radially. The particular shaft can also be present as an intermediate piece, via which a particular component is connected, for example, radially.

Within the meaning of the invention, “axially” means an orientation in the direction of a longitudinal central axis, along which the planetary gear sets are arranged coaxially to one another. “Radially” is then understood to mean an orientation in the direction of the diameter of a shaft that lies on this longitudinal central axis.

Preferably, the output shaft of the transmission includes a tooth system, via which the output shaft is then operatively connected, in the motor vehicle drive train, to a differential gear arranged axially parallel to the output shaft. In this case, the tooth system is preferably provided at a mounting interface of the output shaft, wherein this mounting interface of the output shaft is preferably situated axially in the area of an end of the transmission, at which a mounting interface of the first input shaft is also provided, the mounting interface establishing the connection to the upstream prime mover. This type of arrangement is particularly suitable for the application in a motor vehicle having a drive train aligned transversely to the direction of travel of the motor vehicle.

Alternatively, an output of the transmission can also be provided, in principle, at an axial end of the transmission situated opposite a mounting interface of the first input shaft. In this case, a mounting interface of the output shaft is then designed at an axial end of the output shaft coaxially to a mounting interface of the first input shaft such that the input and the output of the transmission are located at opposite axial ends of the transmission. A transmission configured in this way is suitable for the application in a motor vehicle having a drive train aligned in the direction of travel of the motor vehicle.

The planetary gear sets are preferably arranged in the sequence first planetary gear set, second planetary gear set, and, finally, third planetary gear set axially following the mounting interface of the first input shaft. Alternatively, a sequence of the planetary gear sets deviating therefrom can be implemented in the axial direction, however, provided the connection of the elements of the planetary gear sets enables this.

According to example aspects:
a first element of a first planetary gear set is connected to the second input shaft;
a second element of the first planetary gear set is connected to the first input shaft;
a third element of the first planetary gear set is connected to a first element of a third planetary gear set;
a first element of a second planetary gear set is fixed at a rotationally fixed component;
a third element of the second planetary gear set is connected to a second element of the third planetary gear set;
the third element of the third planetary gear set is connected to the output shaft;
a first shift element is arranged and configured for connecting the first input shaft to the second element of the third planetary gear set;
a second shift element is arranged and configured for connecting the first input shaft to the first element of the first planetary gear set;
a third shift element is arranged and configured for connecting a second element of the second planetary gear set to the output shaft; and
a fourth shift element is arranged and configured for connecting a third element of the first planetary gear set to the second element of the second planetary gear set.

Thus, by actuating the first shift element, the first input shaft and the second element of the first planetary gear set are connected to each other in a rotationally fixed manner, while an actuation of the second shift element results in a rotationally fixed connection between the first input shaft and the first element of the first planetary gear set. The third shift element, in the actuated state, connects the second element of the planetary gear set and the output shaft in a rotationally fixed manner, whereas an actuation of the fourth shift element results in a rotationally fixed connection between the third element of the first element and the second element of the second planetary gear set.

The first shift element, the second shift element, the third shift element, and the fourth shift element are preferably present as form-locking shift elements, in particular as dog clutches.

A particular rotationally fixed connection of the rotatable components of the transmission is implemented, in particular, via one or also multiple intermediate shaft(s), which can also be present as short intermediate pieces when the components are positioned in a spatially dense manner. Specifically, the components that are permanently rotationally fixed to each other can each be present either as individual components that are rotationally fixed to each other, or also as single pieces. In the second case mentioned above, the particular components and the optionally present shaft are then formed by one common component, wherein this is implemented, in particular, when the particular components are situated spatially close to one another in the transmission.

In the case of components of the transmission that are rotationally fixed to each other only upon actuation of a particular shift element, a connection is also preferably implemented via one or also multiple intermediate shaft(s).

A fixation takes place, in particular, by way of a rotationally fixed connection to a rotationally fixed component of the transmission, which is preferably a permanently non-rotating component, preferably a housing of the transmission, a part of such a housing, or a component rotationally fixed thereto.

Within the meaning of the invention, the “connection” of the rotor of the electric machine to the second input shaft of the transmission is to be understood as a connection of such a type that a constant rotational-speed dependence prevails between the rotor of the electric machine and the second input shaft.

The term “interlock” is to be understood to refer to the simultaneous connection of two elements of the same planetary gear set. If a planetary gear set is interlocked, the ratio is always one (1) regardless of the number of teeth. In other words, the planetary gear set revolves as a block.

Overall, a transmission according to example aspects of the invention is distinguished by a compact design, low component loads, good gearing efficiency, and low losses.

The first planetary gear set can be interlocked, for example, by way of the second shift element the second shift element connecting the first element of the first planetary gear set to the second element of the first planetary gear set; or connecting the second element of the first planetary gear set to the third element of the first planetary gear set; or connecting the first element of the first planetary gear set to the third element of the first planetary gear set.

By the transmission, four mechanical gears that differ in terms of the transmission ratio can be brought about via selective actuation of the at least four shift elements. This preferably yields:
a first gear by actuating the second and the third shift elements;
a second gear by actuating the first and the third shift elements;
a third gear by actuating the first and the fourth shift elements; and
a fourth gear by actuating the second and the fourth shift elements.

One additional gear can be brought about by actuating the first and the second shift elements. Therefore, up to five mechanical forward gears can be provided.

Given a suitable selection of stationary transmission ratios of the planetary gear sets, a transmission ratio range that is suitable for the application in the area of a motor vehicle is implemented as a result. Gear shifts between the gears can be implemented, in which always only the state of one shift element is to be varied by disengaging one of the shift elements contributing to the preceding gear and actuating another shift element in order to implement the subsequent gear. As a further consequence thereof, a shift between the gears can take place very rapidly.

The five forward gears can be brought about under purely electric motor power, under purely internal combustion engine power, or in a hybrid manner. The transmission ratio of the first electric gear is the same as the transmission ratio of the first internal combustion engine gear. The transmission ratio of the second electric gear is the same as the transmission ratio of the second internal combustion engine gear, etc.

Starting from electric driving, the internal combustion engine can be re-started in each gear step.

In addition, an electrodynamic starting operation (EDA) can be implemented. EDA means that a speed superimposition of the rotational speed of the internal combustion engine, the rotational speed of the electric machine, and the rotational speed of the output shaft takes place via one or multiple planetary gear set(s) such that it is possible to pull away from rest while the internal combustion engine is running. The electric machine supports a torque in this case.

This yields a first electrodynamic mode by actuating the third shift element; a second electrodynamic mode by actuating the first shift element; and a third electrodynamic mode by actuating the fourth shift element.

In the first EDA mode, an EDA state is brought about at the first planetary gear set by actuating the third shift element. The internal combustion engine drives the second element of the first planetary gear set, while the electric machine simultaneously supports the torque of the internal combustion engine at the first element of the first planetary gear set. The third element of the first planetary gear set is connected to the output via the constant ratio of the second planetary gear set. In this way, an electrodynamic starting operation forward is possible. From the first EDA mode, the internal combustion engine can be utilized for the first and the second gears, because the third shift element is engaged in each of these gears.

In the second EDA mode, an EDA state is brought about at the first and the third planetary gear sets by actuating the first shift element. The internal combustion engine drives the second element of the first and the third planetary gear sets, while the electric machine simultaneously supports the torque of the internal combustion engine at the first element of the first planetary gear set. The third element of the third planetary gear set is connected to the output. In this way, an electrodynamic starting operation forward is possible. From the second EDA mode, the internal combustion engine can be utilized for the second, third, and fifth gears, because the first shift element is engaged in each of these gears.

In the third EDA mode, another EDA state is brought about at the first planetary gear set by actuating the fourth shift element. The internal combustion engine drives the second element of the first planetary gear set, while the electric machine simultaneously supports the torque of the internal combustion engine at the first element of the first planetary gear set. The third element of the first planetary gear set is connected to the second element of the second planetary gear set. In this way, an electrodynamic starting operation forward is possible. From the third EDA mode, the internal combustion engine can be utilized for the third and the fourth gears, because the fourth shift element is engaged in each of these gears.

As a further operating mode, a charging operation of an electrical energy accumulator can also be implemented by engaging only the second shift element and, thus, establishing a rotationally fixed connection of the first input shaft to the second input shaft and, thus, also a coupling of the electric machine to the first input shaft. At the same time, a force-fit connection to the output shaft is not established, and therefore the transmission is in a neutral position. Apart from a charging operation, a start of the upstream prime mover via the electric machine can also be implemented as a result. Starting from this state, a transition into the first gear is possible by actuating the third shift element.

Moreover, powershifts can be implemented with tractive force support. In particular, the changeovers from the first gear into the second gear, from the second gear into the third gear, and from the third gear into the fourth gear can be carried out under load.

Thus, the second and the third shift elements are actuated, for example, starting from the first gear. The drive power of the electric machine and the drive power of the internal combustion engine are set such that, on the one hand, the desired output torque is provided and, on the other hand, the second shift element, which is to be disengaged, becomes load-free. Now the second shift element can be disengaged. Thereafter, the drive power of the electric machine and the drive power of the internal combustion engine are set such that, on the one hand, the desired output torque is provided and, on the other hand, the rotational speed of the first input shaft connected to the internal combustion engine decreases. When the first shift element, which is to be engaged, is synchronized, it is engaged. As a result, the second gear for the internal combustion engine is mechanically engaged.

The gear shifts from the second gear into the third gear and from the third gear into the fourth gear are carried out in a similar way.

Downshifts are carried out similarly to the above-described upshifts but in the reverse sequence. In addition, thrust shifts are possible, in which the internal combustion engine operates in the coasting condition, since the electric machine can support torques at the planetary gear set in a decelerating manner.

According to one further example embodiment of the invention, the first input shaft can be connected in a rotationally fixed manner, via a fifth shift element, to a connection shaft, which is then preferably coupled within a motor vehicle drive train to the internal combustion engine connected upstream from the transmission. The fifth shift element can be designed, in principle, as a force-locking or also as a form-locking shift element in this case, although it is particularly preferred when it is present as a dog clutch. Via the fifth shift element, the upstream internal combustion engine can therefore also be completely decoupled from the transmission such that a purely electric operation is implementable in a problem-free manner.

In one example refinement of the invention, one or multiple shift element(s) is/are implemented as a form-locking shift element. In this case, the particular shift element is preferably designed either as a constant-mesh shift element or as a lock-synchronizer mechanism. Form-locking shift elements have the advantage over friction-locking shift elements that lower drag losses occur in the disengaged state, and therefore a better efficiency of the transmission can be achieved. In particular, in the transmission according to example aspects of the invention, all shift elements are implemented as form-locking shift elements, and therefore the lowest possible drag losses can be achieved. It is preferred when the seventh shift element, which is provided if necessary, is also designed as a force-locking shift element. In principle, however, one shift element or multiple shift elements could also be configured as force-locking shift elements, for example, as lamellar shift elements.

The planetary gear sets are preferably each present as a negative or minus planetary gear set. A minus planetary gear set is composed, in a way known, in principle, to a person skilled in the art, of the elements sun gear, planet carrier, and ring gear, wherein the planet carrier guides, in a rotatably mounted manner, at least one, preferably, however, multiple planet gear(s), each of which individually meshes with the sun gear as well as with the surrounding ring gear.

According to one further example embodiment of the invention, the first shift element and the second shift element are combined to form a shift element pair, with which one actuating element is associated. The first shift element, on the one hand, and the second shift element, on the other hand, can be actuated via the actuating element starting from a neutral position. This has the advantage that, due to this combination, the number of actuating elements can be reduced and, thus, the manufacturing complexity can also be reduced. The additional, fifth gear is omitted in this example embodiment.

Alternatively or also in addition to the aforementioned example variants, the third shift element and the fourth shift element are combined to form a shift element pair, with which one actuating element is associated. The third shift element, on the one hand, and the fourth shift element, on the other hand, can be actuated via this actuating element starting from a neutral position. As a result, the manufacturing complexity can be reduced since one actuating unit can be utilized for both shift elements due to the combination of the two shift elements to form a shift element pair.

It is particularly preferred, however, when both aforementioned shift element pairs are implemented, so that the four shift elements of the transmission can be actuated via two actuating elements. As a result, a particularly low manufacturing complexity can be achieved.

According to one example embodiment of the invention, the rotor of the electric machine is rotationally fixed to the second input shaft. Alternatively, according to one example design option of the invention, the rotor is connected to the second input shaft via at least one gear stage. The electric machine can be arranged either coaxially to the planetary gear sets or so as to be situated axially offset with respect thereto. In the former case, the rotor of the electric machine can either be rotationally fixed directly to the second input shaft or coupled thereto via one or also multiple intermediate gear stage(s), wherein the latter allows for a more favorable configuration of the electric machine with higher rotational speeds and lower torques. The at least one gear stage can be designed as a spur gear stage and/or as a planetary gear stage. In the case of a coaxial arrangement of the electric machine, one or multiple of the planetary gear set(s) can then also, more preferably, be arranged axially in the area of the electric machine as well as radially internally with respect thereto, so that the axial installation length of the transmission can be shortened.

If the electric machine is provided axially offset with respect to the planetary gear sets, however, a coupling takes place via one or multiple intermediate gear stage(s) and/or a flexible traction drive mechanism. The one or the multiple gear stage(s) can also be implemented individually, in this case, either as a spur gear stage or as a planetary gear stage. A flexible traction drive mechanism can be either a belt drive or a chain drive.

Within the scope of example aspects of the invention, a starting component can be installed upstream from the transmission, for example a hydrodynamic torque converter or a friction clutch. This starting component can then also be an integral part of the transmission and is utilized for configuring a starting process by enabling a slip speed between the prime mover, which is designed, in particular, as an internal combustion engine, and the first input shaft of the transmission. One of the shift elements of the transmission or the separating clutch, which may be present, can also be designed as such a starting component by being present as a frictional shift element. In addition, a one-way clutch with respect to the transmission housing or to another shaft can be arranged on each shaft of the transmission, in principle.

The transmission according to example aspects of the invention is, in particular, part of a motor vehicle drive train for a hybrid or electric vehicle and is then arranged between a prime mover of the motor vehicle, which is configured as an internal combustion engine or as an electric machine, and further components of the drive train, which are arranged downstream in the direction of power flow to driving wheels of the motor vehicle. The first input shaft of the transmission is either permanently coupled to a crankshaft of the internal combustion engine or to the rotor shaft of the electric machine in a rotationally fixed manner or is connectable thereto via an intermediate separating clutch or a starting component, wherein a torsional vibration damper can also be provided between an internal combustion engine and the transmission. On the output end, the transmission is then preferably coupled, within the motor vehicle drive train, to a differential gear of a drive axle of the motor vehicle, wherein a connection to an interaxle differential can also be present in this case, however, via which a distribution to multiple driven axles of the motor vehicle takes place. The differential gear or the interaxle differential can be arranged with the transmission in one common housing. A torsional vibration damper, which is optionally present, can also be integrated into this housing.

The above-described transmission can be, in particular, an integral part of an all-wheel concept. Combination as an all-wheel drive system with a second, purely electrically driven axle. In an example variant of this type, the transmission can be utilized, in particular, as a front-wheel drive, while an additional axle drive having a separate second electric machine is provided on the rear axle. The following additional functions can then be represented.

The above-described EDA modes are power-split E-CVT operating modes for the internal combustion engine, in which a battery-neutral operation is also possible (E-CVT function).

A serial driving operation is also possible. When the second and the fifth shift elements are engaged (transmission is in the “charging in Neutral” state), the electric machine can generate current for the separate second electric machine.

The second electric machine can support the tractive force when shifting processes, in which the output of the transmission becomes load-free, are necessary in the transmission. Such transitions are, for example, described below.

Electric driving with the first electric machine (and, optionally, with the second electric machine), then starting the internal combustion engine in Neutral with the first electric machine.
Initially a load transition takes place from the first electric machine onto the second electric machine, by means of which the first electric machine becomes load-free.
The first electric machine utilizes the first electric gear.
The third shift element can now be disengaged.
Thereafter, the fifth shift element (clutch K0) can be engaged and the internal combustion engine can be started.

Start the internal combustion engine or a serial driving operation, then transition into the first EDA mode.
Basic condition: the second and the fifth shift elements are engaged.
load reduction at the internal combustion engine and at the first electric machine such that the second shift element becomes load-free simultaneously, the second electric machine intermittently takes on the load, so that the entire tractive force is maintained
Disengage the second shift element.
Synchronize the third shift element with closed-loop control of the rotational speed of the first electric machine. For this purpose, it may be necessary that the first electric machine rotate backwards.
Engage the third shift element.
The first EDA mode is established.

From this state, it is possible to drive both vehicle axles starting with the vehicle at a standstill even when the energy accumulator is depleted or dead. This would not be possible in the serial mode, which does not have an all-wheel function.

Within the meaning of the invention, the expressions that two components of the transmission are “connected” or “coupled” or “are connected to each other” mean a permanent coupling of these components such that these components cannot rotate independently of each other. In that respect, a shift element is not provided between these components, which can be elements of the planetary gear sets and/or also shafts and/or a rotationally fixed component of the transmission. Instead, the appropriate components are coupled to each other with a consistent rotational speed dependence.

However, if a shift element is provided between two components, these components are not permanently coupled to each other. Instead, a coupling is carried out only by actuating the intermediate shift element. An actuation of the shift element means, within the meaning of the invention, that the relevant shift element is transferred into an engaged state and, consequently, synchronizes the turning motions, if necessary, of the components directly connected thereto. In the case of an embodiment of the relevant shift element as a form-locking shift element, the components directly connected to each other in a rotationally fixed manner via the shift element rotate at the same rotational speed, while, in the case of a force-locking shift element, speed differences can exist between the components also after an actuation of the force-locking shift element. This intentional or also unintentional state is nevertheless referred to, within the scope of the invention, as a rotationally fixed connection of the particular components via the shift element.

### BRIEF DESCRIPTION OF THE DRAWINGS

Advantageous embodiments of the invention, which are explained in the following, are represented in the drawings, in which:

FIG. 1 shows a diagrammatic view of a motor vehicle having a motor vehicle drive train;

FIGS. 2 to 4 each show a diagrammatic view of a transmission of the type that can be utilized in the motor vehicle drive train from FIG. 1;

FIGS. 5 to 7 each show an exemplary gear shift matrix of the transmissions from FIGS. 2 to 4;

FIGS. 8 to 10 each show a diagrammatic view of a transmission of the type that can likewise be utilized in the motor vehicle drive train from FIG. 1;

FIGS. 11 to 13 each show a diagrammatic view of a transmission of the type that can likewise be utilized in the motor vehicle drive train from FIG. 1;

FIGS. 14, 15 each show an exemplary gear shift matrix of the transmissions from FIGS. 11 to 13; and

FIGS. 16 to 18 each show a diagrammatic view of a transmission of the type that can likewise be utilized in the motor vehicle drive train from FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

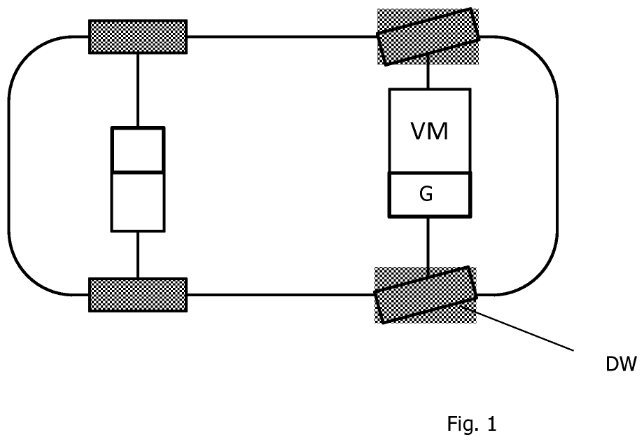

FIG. 1 shows a diagrammatic view of a motor vehicle drive train of a hybrid vehicle, wherein, in the motor vehicle drive train, an internal combustion engine VM is connected to a transmission G via an intermediate torsional vibration damper (not represented). Connected downstream from the transmission G, on the output end thereof, is a differential gear (not represented), via which a drive power is distributed to driving wheels DW of a drive axle of the motor vehicle. The transmission G and the torsional vibration damper are arranged in a common housing of the transmission G, into which the differential gear can then also be integrated. As is also apparent in FIG. 1, the internal combustion engine VM and the transmission G are aligned transversely to a direction of travel of the motor vehicle. The hybrid vehicle optionally includes a drive on the rear axle, including an electric machine and a transmission.

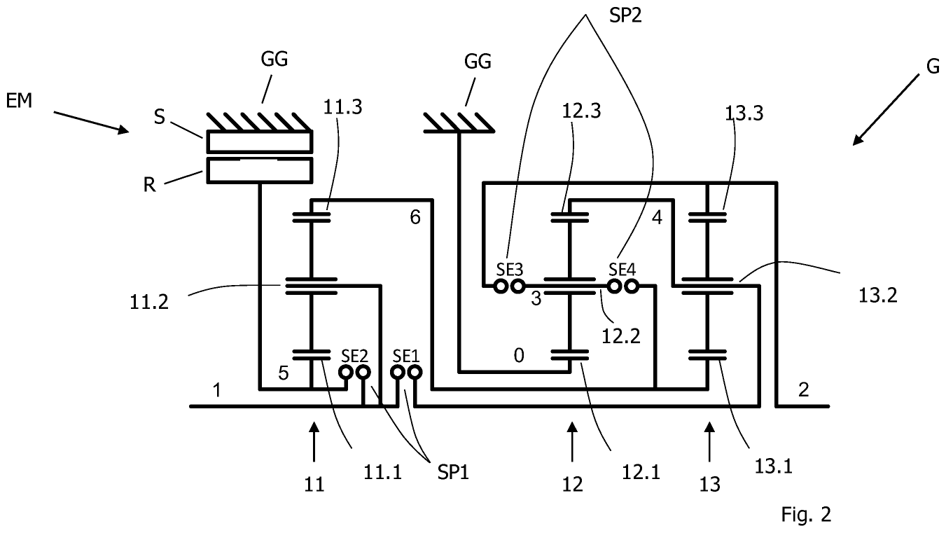

FIG. 2 shows a schematic of the transmission G according to a first example embodiment of the invention. As is apparent, the transmission G includes a gear set RS and an electric machine EM, which are both arranged in the housing of the transmission G. The gear set includes three planetary gear sets 11, 12, and 13, wherein each of the three planetary gear sets includes a first element 11.1, 12.1, and 13.1, respectively, a second element 11.2, 12.2, and 13.2, respectively, and a third element 11.3, 12.3, and 13.3, respectively. The particular first element is formed, in each case, by a sun gear of the particular planetary gear set, while the particular second element of the particular planetary gear set is present as a planet carrier and the particular third element of the particular planetary gear set is present as a ring gear.

In the present case, the first planetary gear set 11, the second planetary gear set 12, and the third planetary gear set 13 are each present as a negative or minus planetary gear set. The particular planet carrier thereof guides at least one planet gear in a rotatably mounted manner; the planet gear is meshed with the particular radially internal sun gear as well as with the particular radially surrounding ring gear. It is particularly preferred, however, when multiple planet gears are provided in the first planetary gear set 11, in the second planetary gear set 12, and also in the third planetary gear set 13.

As is apparent in FIG. 2, the transmission G includes a total of four shift elements in the form of a first shift element SE1, a second shift element SE2, a third shift element SE3, and a fourth shift element SE4. The shift elements SE1, SE2, SE3, and SE4 are each designed as form-locking shift elements and are preferably present as constant-mesh shift elements. In addition, the shift elements SE1, SE2, SE3, and SE4 are each designed as clutches.

The first element 11.1 of the first planetary gear set 11 is permanently connected to the second input shaft 5. The second input shaft 5 is rotationally fixed to a rotor R of the electric machine EM, the stator S of which is permanently fixed at the rotationally fixed component GG. The second element 11.2 of the first planetary gear set 11 is connected to the first input shaft 1. The third element 11.3 of the first planetary gear set 11 is connected via a shaft 6 to the first element 13.1 of the third planetary gear set 13. The first element 12.1 of the second planetary gear set 12 is permanently fixed via a component 0 at a rotationally fixed component GG, which is preferably the transmission housing of the transmission G or a portion of this transmission housing. Therefore, the first element 12.1 of the second planetary gear set 12 is permanently prevented from making a turning motion. The third element 12.3 of the second planetary gear set 12 is connected via a shaft 4 to the second element 13.2 of the third planetary gear set 13. The third element 13.3 of the third planetary gear set 13 is connected to the output shaft 2. The second element 12.2 includes a shaft 3.

The first shift element (SE1) can connect the first input shaft (1) to the second element (13.2) of the third planetary gear set (13). In other words, if the first shift element SE1 has been actuated, the input shaft 1 is then connected to the shaft 4.

The second shift element (SE2) can interlock the first planetary gear set (11). According to the example embodiment from FIG. 2, this takes place by the first element 11.1 being connected to the second element 11.2 of the first planetary gear set 11. In other words, if the second shift element SE2 has been actuated, the first input shaft 1 is then connected to the second input shaft 5.

The third shift element SE3 can connect the second element 12.2 of the second planetary gear set 12 to the output shaft 2. In other words, if the third shift element SE3 has been actuated, the output shaft 2 is then connected to the shaft 3.

The fourth shift element SE4 can connect the third element 11.3 of the first planetary gear set 11 to the second element 12.2 of the second planetary gear set 12. In other words, if the fourth shift element SE4 has been actuated, the shaft 3 is then connected to the shaft 6.

The first input shaft 1 as well as the output shaft 2 each have a mounting interface, wherein the mounting interface of the input shaft 1 in the motor vehicle drive train from FIG. 1 is utilized for a connection to the internal combustion engine VM. The mounting interface of the output shaft 2 is utilized for a connection to the downstream differential gear. The mounting interface of the first input shaft 1 is formed at one axial end of the transmission G, wherein the mounting interface of the output shaft 2 is situated at the axially opposite end. In addition, the first input shaft 1, the second input shaft 5, and the output shaft 2 are arranged coaxially to each other.

The planetary gear sets 11, 12, and 13 are also situated coaxially to the input shafts 1, 5 and to the output shaft 2, wherein the planetary gear sets 11, 12, and 13 are arranged in the sequence first planetary gear set 11, second planetary gear set 12, and third planetary gear set 13 axially following the mounting interface of the first input shaft 1. Likewise, the electric machine EM is also located coaxially to the planetary gear sets 11, 12, and 13 and, thus, also to the input shafts 1 and 5 as well as to the output shaft 2, wherein the electric machine EM is located axially on a side of the first planetary gear set 11 facing away from the second planetary gear set 12.

As is also apparent from FIG. 2, the first shift element SE1 and the second shift element SE2 are arranged axially between the first planetary gear set P1 and the second planetary gear set P2, wherein the first shift element SE1 is located axially between the second planetary gear set 12 and the second shift element SE2. The first shift element SE1 and the second shift element SE2 are situated axially directly next to each other and radially at the same level and are combined to form a shift element pair SP1 by way of a common actuating element being associated with the first shift element SE1 and the second shift element SE2. By means of the common actuating element, the first shift element SE1, on the one hand, and the second shift element SE2, on the other hand, can be actuated from a neutral position.

The third shift element SE3 is arranged axially between the first planetary gear set 11 and the second planetary gear set 12. The fourth shift element SE4 is arranged axially between the second planetary gear set 12 and the third planetary gear set 13. The third shift element SE3 and the fourth shift element SE4 are located radially at the same level and have a common actuating element, via which the third shift element SE3, on the one hand, and the fourth shift element SE4, on the other hand, can be actuated from a neutral position. Therefore, the third shift element SE3 and the fourth shift element SE4 are combined to form a shift element pair SP2.

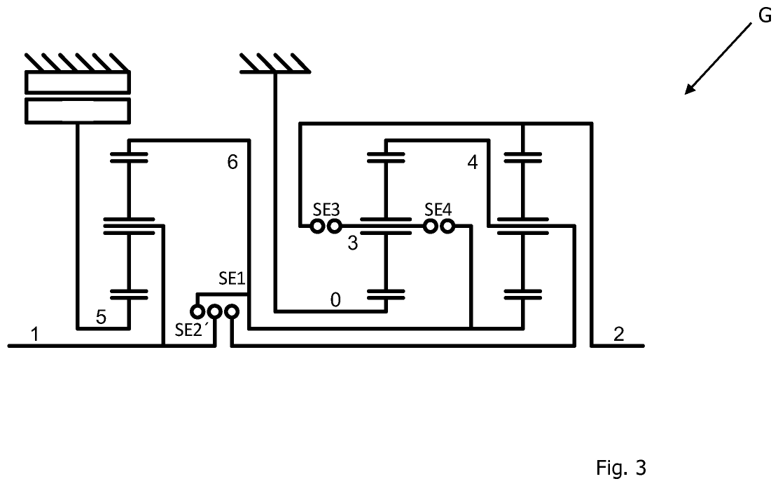

FIG. 3 shows a diagrammatic view of a transmission G according to a second example design option of the invention, which can likewise be utilized in the motor vehicle drive train from FIG. 1. This example design option of FIG. 3 largely corresponds to the preceding example embodiment from FIG. 2, with the difference that the second shift element SE2′ brings about the interlock of the first planetary gear set 11 by connecting the second element 11.2 and the third element 11.3. An actuation of the second shift element SE2′ therefore results in a rotationally fixed connection of the second element 11.2 and the third element 11.3 of the first planetary gear set 11. This example embodiment, therefore, is an interlock variant. Otherwise, the example embodiment according to FIG. 3 corresponds to the example embodiment according to FIG. 2, and therefore reference is made to the description thereof in this regard.

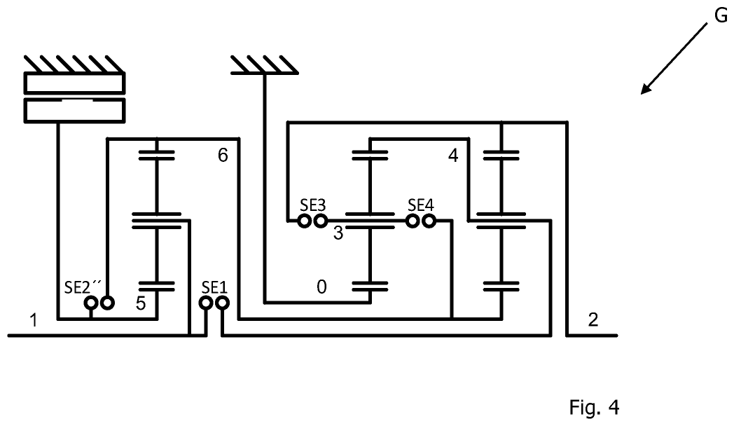

FIG. 4 shows a diagrammatic view of a transmission G according to a third example design option of the invention, which can likewise be utilized in the motor vehicle drive train from FIG. 1. This design option of FIG. 4 largely corresponds to the preceding example embodiment from FIG. 2, with the difference that the second shift element SE2″ brings about the interlock of the first planetary gear set 11 by connecting the second element 11.1 and the third element 11.3. An actuation of the second shift element SE2″ therefore results in a rotationally fixed connection of the first element 11.1 and the third element 11.3 of the first planetary gear set 11. This example embodiment, therefore, is one further interlock example variant. Otherwise, the example embodiment according to FIG. 4 corresponds to the example embodiment according to FIG. 2, and therefore reference is made to the description thereof.

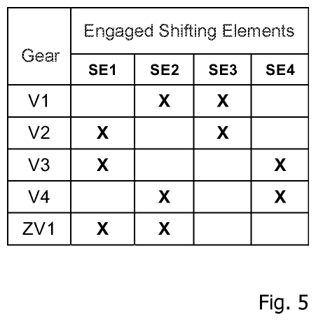

FIG. 5 shows an exemplary gear shift matrix for the transmissions G from FIGS. 2 through 4 in table form. As is apparent, a total of five gears, which differ in terms of the transmission ratio, can be implemented between the first input shaft 1 and the output shaft 2, wherein, in the columns of the gear shift matrix, an X indicates which of the shift elements SE1 through SE4 is engaged in which of the gears.

A first gear V1 between the first input shaft 1 and the output shaft 2 is engaged by actuating the second shift element SE2 and the third shift element SE3. A second gear V2 between the first input shaft 1 and the output shaft 2 is engaged by actuating the third shift element SE3 and the first shift element SE1. A third gear V3 between the first input shaft 1 and the output shaft 2 is engaged by actuating the fourth shift element SE4 and the first shift element SE1. A fourth gear V4 between the first input shaft 1 and the output shaft 2 is engaged by actuating the fourth shift element SE4 and the second shift element SE2. In addition, an additional gear ZV1 is engaged by actuating the first shift element SE1 and the second shift element SE2. This additional gear ZV1 is possible only for the case in which the first shift element SE1 and the second shift element SE2 are not combined to form the shift element pair SP1.

Although the shift elements SE1 through SE4 are each designed as form-locking shift elements, a shift between the first gear V1 and the second gear V2, between the second gear V2 and the third gear V3, and between the third gear V3 and the fourth gear V4 can each be carried out under load.

The reason therefor is that
The third shift element SE3 remains engaged from the first gear V1 into the second gear V2,
the first shift element SE1 remains engaged from the second gear V2 into the third gear V3, and
the fourth shift element SE4 remains engaged from the third gear V3 into the fourth gear V4.

The gear shift is carried out electrodynamically by the electric machine.

This is to be illustrated in greater detail using the example of the gear shift from the first gear V1 into the second gear V2:
1 In the starting gear V1, the second shift element SE2 and the third shift element SE3 are engaged. The first input shaft 1 is connected to the internal combustion engine VM.
2. The torques of the internal combustion engine VM and of the electric machine EM are set such that, on the one hand, the desired output torque is provided and, on the other hand, the second shift element SE2, which is to be disengaged, becomes load-free.
3. The second shift element SE2 is disengaged.
4. The torques of the internal combustion engine VM and of the electric machine EM are set such that, on the one hand, the desired output torque is provided and, on the other hand, the rotational speed of the internal combustion engine decreases.
5. When the shift element SE1, which is to be engaged, is synchronized, it is engaged. As a result, the second gear V2 for the internal combustion engine VM is mechanically engaged.
6. The V3-V4 gear shift takes place, in principle, similarly to the V1-V2 gear shift. Downshifts are carried out similarly to upshifts but in the reverse sequence.

For the sake of clarity, only one of the three example variants of the second shift element is represented in the gear shift matrix, namely “SE2.” In this context, “SE2” represents all three interlock example variants of the second shift element.

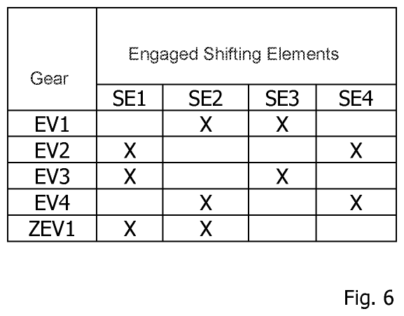

FIG. 6 shows one further exemplary gear shift matrix for the transmissions G from FIGS. 2 through 4 in table form. As is apparent, a total of five gears, which differ in terms of the transmission ratio, can be implemented between the second input shaft 5, which is connected to the electric machine, and the output shaft 2, wherein, in the columns of the gear shift matrix, an X indicates which of the shift elements SE1 through SE4 is engaged in which of the gears.

A first gear EV1 between the second input shaft 5 and the output shaft 2 is engaged by actuating the second shift element SE2 and the third shift element SE3. A second gear EV2 between the second input shaft 5 and the output shaft 2 is engaged by actuating the fourth shift element SE4 and the first shift element SE1. A third gear EV3 between the second input shaft 5 and the output shaft 2 is engaged by actuating the third shift element SE3 and the first shift element SE1. A fourth gear EV4 between the second input shaft 5 and the output shaft 2 is engaged by actuating the fourth shift element SE4 and the second shift element SE2. In addition, an additional gear ZEV1 is engaged by actuating the first shift element SE1 and the second shift element SE2. This additional gear ZEV1 is possible only for the case in which the first shift element SE1 and the second shift element SE2 are not combined to form the shift element pair SP1. The five aforementioned gears are possible under purely electric motor power. The internal combustion engine can be decoupled.

Since the electric machine EM is not located on the first input shaft 1, the electric gears from FIG. 6 do not always correspond to the mechanical gears from FIG. 5. Only for the case in which the second shift element SE2 is engaged do the electric gears correspond to the mechanical gears in terms of their ratio, i.e., in the first gear, in the fourth gear, and in the additional gear. The second gear V2 differs from the second gear EV2. In addition, the third gear V3 differs from the third gear EV3.

The first gear, the fourth gear, and the additional gear can therefore be driven in a hybrid manner, i.e., by incorporating the internal combustion engine VM as well as the electric machine EM.

Moreover, a charging function or a start function can be implemented by actuating the second shift element SE2. This is the case because, in the engaged condition of the second shift element SE2, the second input shaft 5 is directly coupled to the first input shaft 1 in a rotationally fixed manner and, thus, also to the internal combustion engine VM. Simultaneously, however, there is no frictional connection to the output shaft 2. When the electric machine EM is operated as a generator, an electric accumulator can be charged via the internal combustion engine VM. When the electric machine EM is operated as an electric motor, a start of the internal combustion engine VM can be implemented via the electric machine EM.

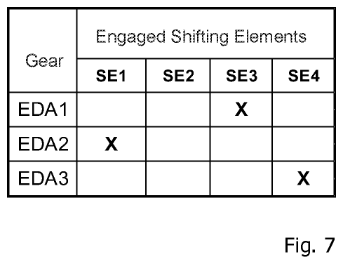

Three EDA states are represented in FIG. 7. A first electrodynamic mode EDA1 results by actuating the third shift element SE3. A second electrodynamic mode EDA2 results by actuating the first shift element SE1. A third electrodynamic mode EDA3 results by actuating the fourth shift element SE4. In each of the EDA modes, the vehicle can pull away from rest when the internal combustion engine is connected.

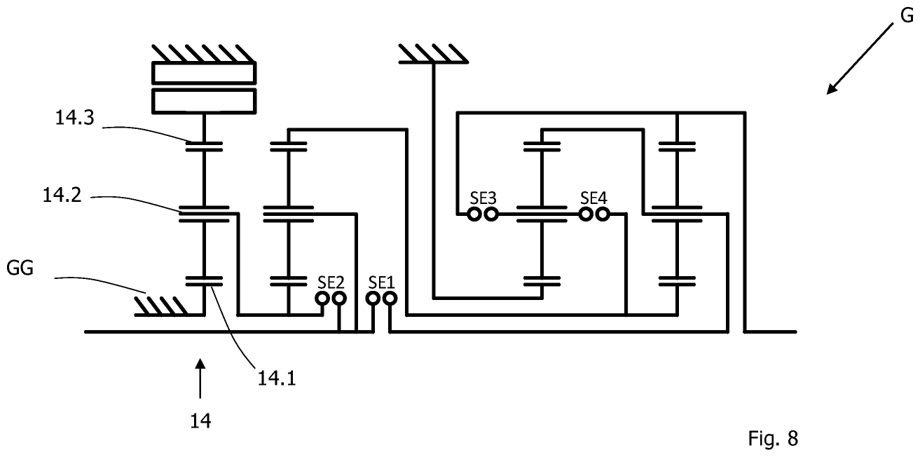

FIG. 8 shows a schematic of a transmission G according to a further example embodiment of the invention, of the type which can likewise be utilized in the motor vehicle drive train from FIG. 1. This example embodiment of FIG. 8 essentially corresponds to the example variant according to FIG. 2, wherein, in contrast thereto, a transmission gearing in the form of a fourth planetary gear set 14 is now provided. The fourth planetary gear set 14 includes a first element 14.1, a second element 14.2, and a third element 14.3. The first element 14.1 is present as a sun gear, the second element 14.2 is present as a planet carrier, and the third element 14.3 is present as a ring gear. The first element 14.1 is fixed at the transmission housing GG. The second element 14.2 is connected to the first element 11.1 of the first planetary gear set 11. The third element 14.3 is connected to the rotor R of the electric machine. The fourth planetary gear set is arranged, practically as a transmission gearing, between the electric machine and the first planetary gear set in order to transmit the rotational speed of the electric machine. In this way, the rotational speed and the torque of the electric machine can be even better adapted to the transmission.

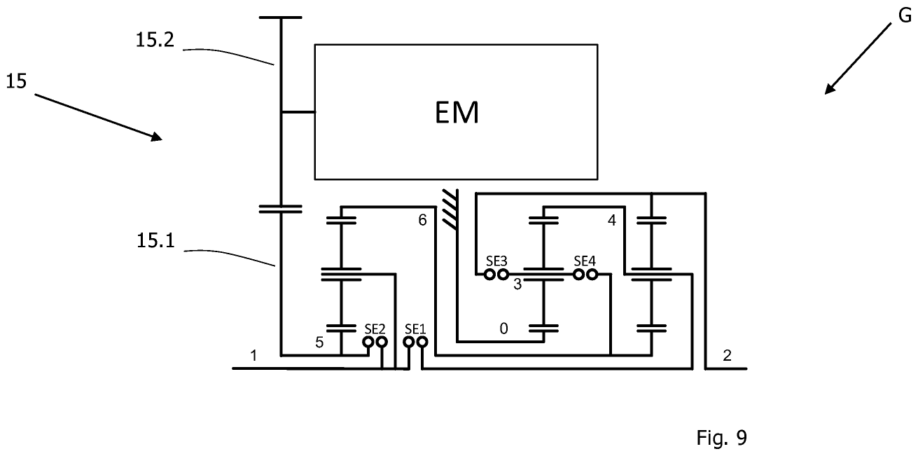

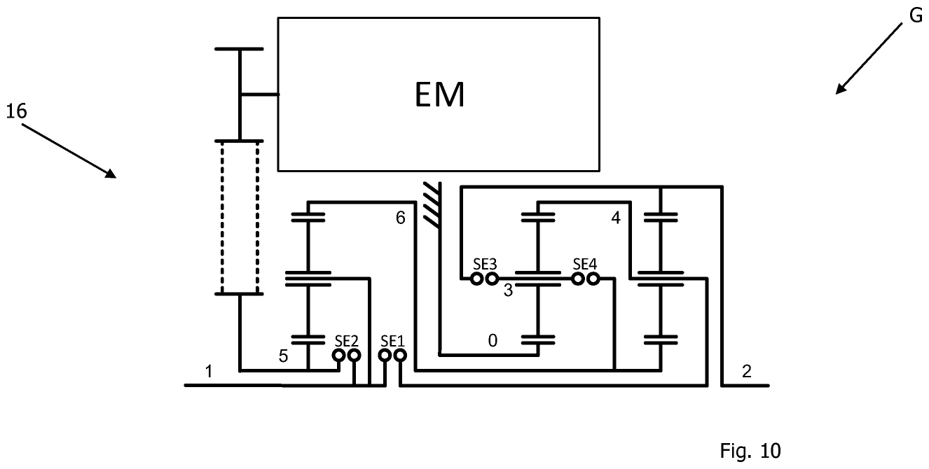

The example embodiments described above each show a transmission G, in which the electric machine is arranged coaxially to the input shafts and to the output shaft. FIGS. 9 and 10 show example embodiments of the invention having an axially parallel arrangement according to example aspects of the invention.

In FIG. 9, the electric machine EM is not located coaxially to the gear set of the transmission G, but rather is arranged axially offset. A connection takes place via a spur gear stage 15, which includes a first spur gear 15.1 and a second spur gear 15.2. The first spur gear 15.1 is connected to the second input shaft 5 in a rotationally fixed manner. The spur gear 15.1 then meshes with the spur gear 15.2 which is located on an input shaft of the electric machine EM in a rotationally fixed manner, which establishes, within the electric machine EM, the connection to the rotor (not represented further in this case) of the electric machine EM.

In the case of the example modification according to FIG. 10 as well, the electric machine EM is located axially offset with respect to the particular gear set RS of the particular transmission G. In contrast to the preceding example variant according to FIG. 9, a connection is not established in this case via a spur gear stage 15, however, but rather via a flexible traction drive mechanism 16. This flexible traction drive mechanism 16 can be configured as a belt drive or also a chain drive. The flexible traction drive mechanism 16 is then connected to the second input shaft 5 on the side of the gear set. Via the flexible traction drive mechanism 16, a coupling to an input shaft of the electric machine EM is then established, which, in turn, establishes a connection to the rotor of the electric machine, within the electric machine EM.

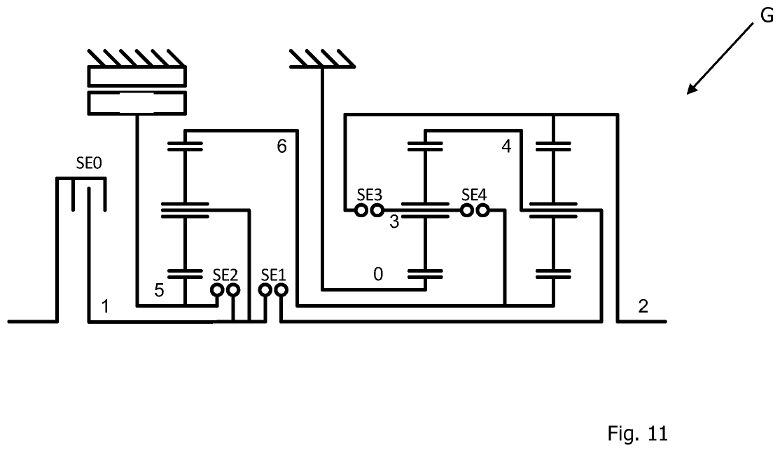

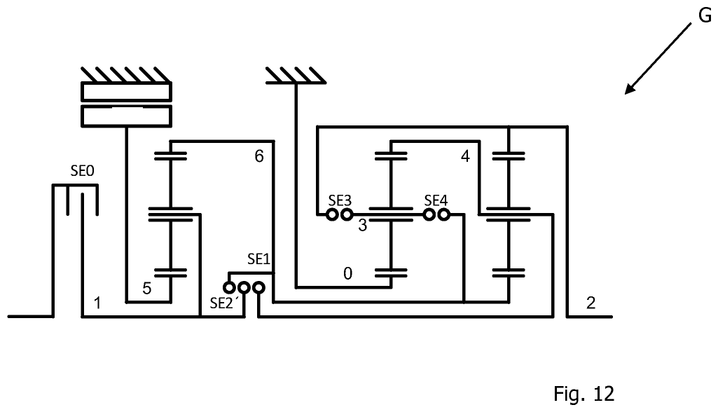

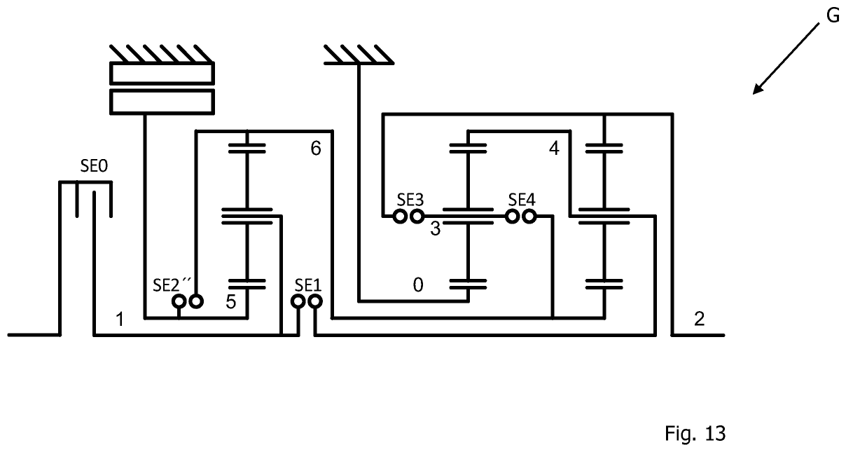

FIGS. 11 through 13 each show a schematic of a transmission G according to a further example embodiment of the invention, of the type which can likewise be utilized in the motor vehicle drive train from FIG. 1. The example embodiment according to FIG. 11 essentially corresponds to the example variant according to FIG. 2. The example embodiment according to FIG. 12 essentially correspond to the variant according to FIG. 3. The example embodiment according to FIG. 13 essentially correspond to the example variant according to FIG. 4. The general difference lies in a fifth shift element SE0, which is also known as a clutch K0, which is arranged between the first input shaft 1 and the internal combustion engine (not represented). Therefore, when the fifth shift element SE0 is disengaged, driving under purely electric motor power is possible. In addition, an engine start is possible, a flywheel start, when the fifth shift element SE5 is engaged. Otherwise, the example embodiment according to FIGS. 11, 12, and 13 correspond to the example embodiment according to FIGS. 2, 3, and 4, respectively, and therefore reference is made to the descriptions thereof in this regard.

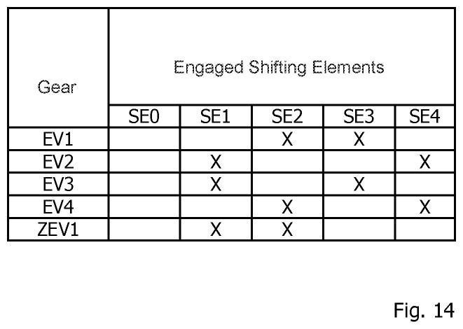

FIG. 14 shows an exemplary gear shift matrix for the transmissions G from FIGS. 11 through 13 in table form. As is apparent, a total of five electric gears, which differ in terms of the transmission ratio, can be implemented between the second input shaft 5 and the output shaft 2, wherein, in the columns of the gear shift matrix, an X indicates which of the shift elements SE1 through SE4 and SE0 is engaged in which of the gears. The difference from the gear shift matrix according to FIG. 6 lies solely in the fifth shift element SE0, which can decouple the internal combustion engine from the first input shaft 1. The fifth shift element SE0 must be disengaged in order to implement the electric gears. Otherwise, the gear shift matrix according to FIG. 14 corresponds to the gear shift matrix according to FIG. 6, and therefore reference is made to the description thereof in this regard.

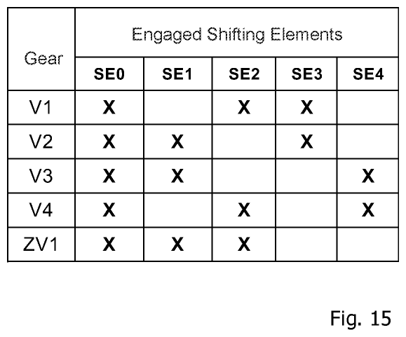

FIG. 15 shows an exemplary gear shift matrix for the transmissions G from FIGS. 11 through 13 in table form. As is apparent, a total of five internal combustion engine gears, which differ in terms of the transmission ratio, can be implemented between the first input shaft 1 and the output shaft 2, wherein, in the columns of the gear shift matrix, an X indicates which of the shift elements SE1 through SE4 and SE0 is engaged in which of the gears.

The difference from the gear shift matrix according to FIG. 5 lies solely in the fifth shift element SE0, which can decouple the internal combustion engine VM from the first input shaft 1. The fifth shift element SE0 must be engaged in order to implement the internal combustion engine gears. Otherwise, the gear shift matrix according to FIG. 15 corresponds to the gear shift matrix according to FIG. 5, and therefore reference is made to the description thereof in this regard.

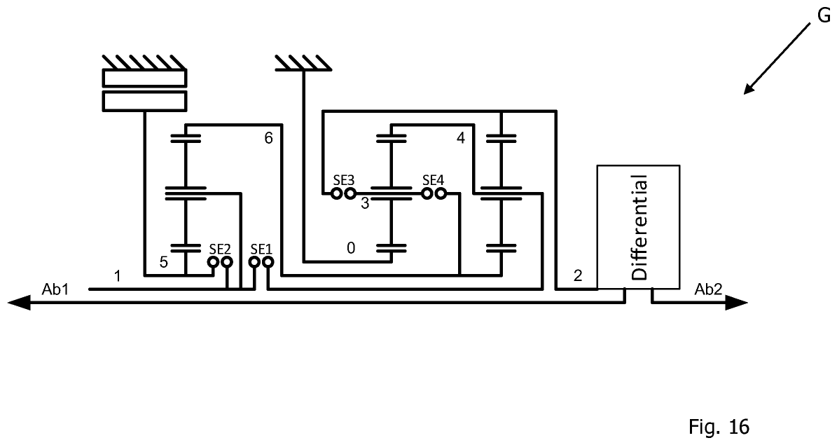

FIG. 16 shows a schematic of a transmission G according to a further example embodiment of the invention, of the type which can likewise be utilized in the motor vehicle drive train from FIG. 1. The example embodiment according to FIG. 16 essentially corresponds to the example variant according to FIG. 2, wherein, by contrast, a differential is connected downstream from the transmission. The differential is therefore connected to the output shaft 2. Starting from the differential 16, two shafts Ab1 and Ab2 are provided, which drive the wheels of the motor vehicle. If this is coaxially connected, it is preferred when one of the two output shafts, as a solid shaft, is guided through the gear set. Otherwise, the example embodiment according to FIG. 16 corresponds to the example embodiment according to FIG. 2, and therefore reference is made to the description thereof in this regard.

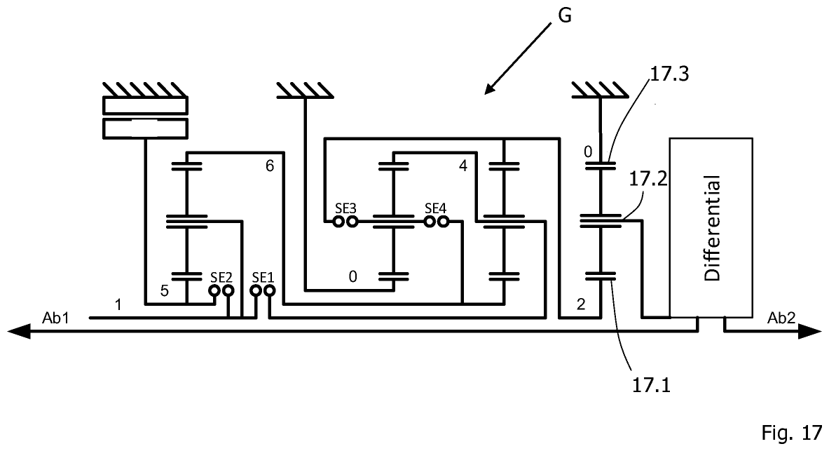

FIG. 17 shows a schematic of a transmission G according to a further example embodiment of the invention, of the type which can likewise be utilized in the motor vehicle drive train from FIG. 1. The example embodiment according to FIG. 17 essentially corresponds to the example variant according to FIG. 16, wherein, by contrast, a transmission gearing 17 is provided, which is arranged between the output shaft 2 and the differential D. Therefore, a higher ratio can be provided. The transmission gearing 17 is designed in the shape of a planetary gear set and includes a first element 17.1, which is connected to the output shaft 2, a second element 17.2, which is connected to the differential D, and a third element 17.3, which is fixed at the transmission housing GG. Otherwise, the example embodiment according to FIG. 17 corresponds to the example embodiment according to FIGS. 16 and 2, and therefore reference is made to the description thereof in this regard.

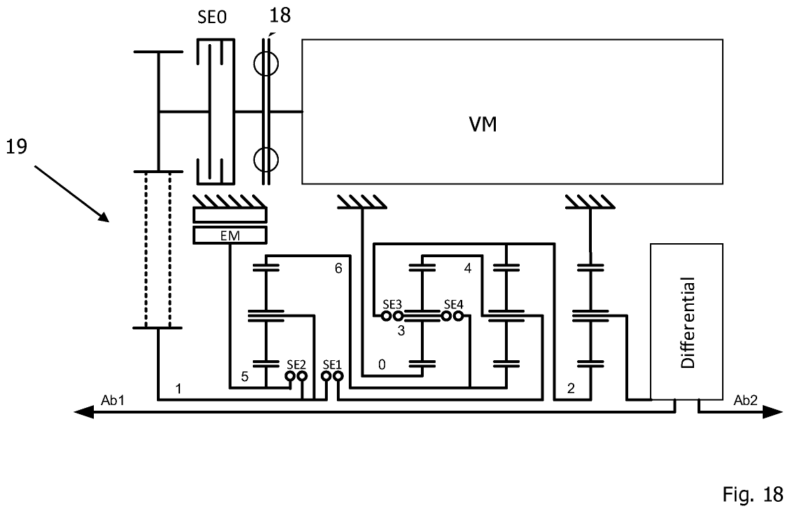

Finally, FIG. 18 shows, by way of example, a schematic of a motor vehicle drive train, which includes a transmission G from FIG. 17, an internal combustion engine VM, a damper 18, a clutch K0 (cf. FIGS. 11-13), and a flexible traction drive mechanism 19. A drive train of this type is suitable, in particular, for front-mounted transverse installation.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

G transmission
GG rotationally fixed component
1 first input shaft
2 output shaft
3 shaft
4 shaft
5 second input shaft
6 shaft
11 first planetary gear set
11.1 first element of the first planetary gear set
11.2 second element of the first planetary gear set
11.3 third element of the first planetary gear set
12 second planetary gear set
12.1 first element of the second planetary gear set
12.2 second element of the second planetary gear set
12.3 third element of the second planetary gear set
13 third planetary gear set
13.1 first element of the third planetary gear set
13.2 second element of the third planetary gear set
13.3 third element of the third planetary gear set
14 fourth planetary gear set
14.1 first element of the fourth planetary gear set
14.2 second element of the fourth planetary gear set
14.3 third element of the fourth planetary gear set
15 spur gear stage
15.1 spur gear
15.2 spur gear
16 flexible traction drive mechanism
17 fifth planetary gear set
17.1 first element of the fifth planetary gear set
17.2 second element of the fifth planetary gear set
17.3 third element of the fifth planetary gear set
18 torsional vibration damper
19 flexible traction drive mechanism
SE1 first shift element
SE2/2′/2″ second shift element
SE3 third shift element
SE4 fourth shift element
SE5 fifth shift element, K0
SP1 shift element pair
SP2 shift element pair
V1 first gear
V2 second gear
V3 third gear
V4 fourth gear
ZV1 additional, fifth gear
E1 first gear
E2 second gear
E3 third gear
E4 fourth gear
ZEV1 additional, fifth gear
EM electric machine
S stator
R rotor
SRS spur gear stage
SR1 spur gear
SR2 spur gear
D differential gear
DW driving wheels
VM internal combustion engine

1.-14: (canceled)

15. A transmission (G) for a motor vehicle drive train of a motor vehicle, comprising:
an electric machine (EM1);
a first input shaft (1);
a second input shaft (5);
an output shaft (2);
a first planetary gear set (11), a second planetary gear set (12), and a third planetary gear set (13), each of the first, second, and third planetary gear sets (11, 12, 13) respectively comprising a first element (11.1, 11.2, 11.3), a second element (12.1, 12.2, 12.3), and a third element (13.1, 13.2, 13.3); and
a first shift element (SE1), a second shift element (SE2, SE2′, SE2″), a third shift element (SE3), and a fourth shift element (SE4),
wherein a rotor (R1) of the electric machine (EM1) is connected to the second input shaft (5),
wherein the first element (11.1) of the first planetary gear set (11) is connected to the second input shaft (5),
wherein the second element (11.2) of the first planetary gear set (11) is connected to the first input shaft (1),
wherein the third element (11.3) of the first planetary gear set (10) is connected to the first element (13.1) of the third planetary gear set (13),
wherein the first element (12.1) of the second planetary gear set (12) is fixed at a rotationally fixed component (GG),
wherein the third element (12.3) of the second planetary gear set (12) is connected to the second element (13.2) of the third planetary gear set (13),
wherein the third element (13.3) of the third planetary gear set (13) is connected to the output shaft (2),
wherein the first shift element (SE1) is arranged and configured for connecting the first input shaft (1) to the second element (13.2) of the third planetary gear set (13),
wherein the second shift element (SE2, SE2′, SE2″) is arranged and configured for interlocking the first planetary gear set (11),
wherein the third shift element (SE3) is arranged and configured for connecting the second element (12.2) of the second planetary gear set (12) to the output shaft (2) and
wherein the fourth shift element (SE4) is arranged and configured for connecting the third element (11.3) of the first planetary gear set (11) to the second element (12.2) of the second planetary gear set (12).

16. The transmission (G) of claim 15, wherein:
the second shift element (SE2) is configured for connecting the first element (11.1) of the first planetary gear set (11) to the second element (11.2) of the first planetary gear set (11); or
the second shift element (SE2′) is configured for connecting the second element (11.2) of the first planetary gear set (11) to the third element (11.3) of the first planetary gear set (11); or
the second shift element (SE2″) is configured for connecting the first element (11.1) of the first planetary gear set (11) to the third element (11.3) of the first planetary gear set (11).

17. The transmission (G) of claim 15, wherein, via selective actuation of the first, second, third, and fourth shift elements (SE1; SE2, SE2′, SE2″; SE3; SE4) between the first input shaft (1) and the output shaft (2):
a first gear (V1) results by actuating the second shift element (SE2) and the third shift element (SE3);
a second gear (V2) results by actuating the first shift element (SE1) and the third shift element (SE3);
a third gear (V3) results by actuating the first shift element (SE1) and the fourth shift element (SE4); and
a fourth gear (V4) results by actuating the second shift element (SE2) and the fourth shift element (SE4).

18. The transmission (G) of claim 15, wherein, via selective actuation of the first, second, third, and fourth shift elements (SE1; SE2, SE2′, SE2″; SE3; SE4) between the second input shaft (5) and the output shaft (2):
a first gear (EV1) results by actuating the second shift element (SE2, SE2′, SE2″) and the third shift element (SE3);
a second gear (EV2) results by actuating the first shift element (SE1) and the fourth shift element (SE4);
a third gear (EV3) results by actuating the first shift element (SE1) and the third shift element (SE3); and
a fourth gear (EV4) results by actuating the second shift element (SE2, SE2′, SE2″) and the fourth shift element (SE4).

19. The transmission of claim 15, wherein:
a first electrodynamic mode (EDA1) results by actuating the third shift element (SE3);
a second electrodynamic mode (EDA2) results by actuating the first shift element (SE1); and
a third electrodynamic mode (EDA3) results by actuating the fourth shift element (SE4).

20. The transmission (G) of claim 15, further comprising a fifth shift element (SE0) arranged and configured for connecting the first input shaft (1) to an internal combustion engine of the motor vehicle drive train.

21. The transmission (G) of claim 15, wherein one or more of the first, second, third, and fourth shift elements (SE1, SE2, SE3, SE4) is implemented as a form-locking shift element.

22. The transmission (G) of claim 15, wherein the first, second, and third planetary gear sets (11, 12, 13) are minus planetary gear sets, the respective first element (11.1, 12.1, 13.1) is a respective sun gear, the respective second element (11.2, 12.2, 13.2) is a respective planet carrier, and the respective third element (11.3, 12.3, 13.3) is a respective ring gear.

23. The transmission (G) of claim 15, wherein:
the first shift element (SE1) and the second shift element (SE2) are combined to form a shift element pair (SP1) with an associated actuating element; and
via the actuating element, either the first shift element (SE1) or the second shift element (SE2) is actuatable from a neutral position.

24. The transmission (G) of claim 15, wherein:
the third shift element (SE3) and the fourth shift element (SE4) are combined to form a shift element pair (SP1) with an associated actuating element; and
via the actuating element, either the third shift element (SE3) or the fourth shift element (SE4) is actuatable from a neutral position.

25. The transmission (G) of claim 15, wherein the rotor (R1) of the electric machine (EM) is rotationally fixed to the second input shaft (5) or is connected to the second input shaft (5) via at least one gear stage.

26. A motor vehicle drive train for a hybrid or electric vehicle, comprising the transmission (G) of claim 15.

27. A method for operating the transmission (G) of claim 15, wherein only the second shift element (SE2) is engaged in order to implement a charging operation or a starting operation.
